(19) United States
(12) Patent Application Publication
(10) Pub. No.: US 2012/0057889 A1
(43) Pub. Date: Mar. 8, 2012

(54) IMAGE PROCESSING APPARATUS, IMAGE FORMING APPARATUS, AND IMAGE PROCESSING METHOD

(75) Inventors: Akinori YAMAGUCHI, Kanagawa (JP); Tatsuya Miyadera, Osaka (JP); Izumi Kinoshita, Hyogo (JP); Kunihiro Komai, Osaka (JP); Yoshinori Shirasaki, Osaka (JP); Takuhei Yokoyama, Osaka (JP); Takeshi Shikama, Osaka (JP)

(73) Assignee: RICOH COMPANY, LTD., Tokyo (JP)

(21) Appl. No.: 13/219,974

(22) Filed: Aug. 29, 2011

(30) Foreign Application Priority Data
Sep. 3, 2010 (JP) 2010-197575

(51) Int. Cl. G03G 15/043

(52) U.S. Cl. 399/51

(57) ABSTRACT

An image processing apparatus for an image forming apparatus including a line head array that forms an image by illuminating one or more illumination elements in correspondence with image data. The image processing apparatus includes a detection part configured to detect a linear image extending in a sub-scanning direction in the image data, and an adjustment part configured to adjust a density of the linear image so that the energy used in illuminating the one or more illumination elements for forming the linear image is reduced compared to the energy used in forming the linear image without adjusting the density of the linear image.

### BACKGROUND OF THE INVENTION

1. Field of the Invention

The present invention relates to an image processing apparatus, an image forming apparatus, and an image processing method.

2. Description of the Related Art

An LEDA (Light Emitting Diode Array) head used in an electrophotographic type image forming apparatus has a characteristic in which the amount of light decreases due to each illumination element (dot) of the LEDA head being degraded by illumination for a long period of time. Particularly, in a case of consecutively printing linear images having lines formed in a sub-scanning direction, the lifespan of the entire LEDA head becomes short because the illumination elements used for forming the linear images degrade faster than the other illumination elements. In order to prevent this problem, there is a known method for dispersing the workload of illumination elements by moving the positions of illumination elements in a main scanning direction whenever a page is printed in a case of consecutively printing images having lines formed in a sub-scanning direction.

One example of this known method is disclosed in Japanese Laid-Open Patent Publication No. 2008-87196. Japanese Laid-Open Patent Publication No. 2008-87196 discloses a method of driving an illumination head in which consecutively arranged illumination elements included in an array of illumination elements arranged in a single direction are designated as valid illumination elements in accordance with the width of the paper on which an image is printed so that the valid illumination elements are used for illumination. This method changes the designation of the valid illumination elements during the intervals of printing one page to printing another page. By using this method, the use of consecutively illuminated illumination elements can be dispersed. Thereby, the lifespan of the illumination head can be increased.

However, the above-described method of moving the positions in the main scanning direction whenever a page is printed has a problem in which an image forming position (image forming area) is shifted in the main scanning direction whenever a page is printed.

The method disclosed in Japanese Laid-Open Patent Publication No. 2008-87196 does reduce the workload per illumination element owing to the designation of valid illumination elements being changed in the main scanning direction whenever a page is printed. However, this method does not solve the problem of deviation of the image forming position per page because the designation of the valid illumination elements is performed by shifting the valid illumination elements in the main scanning direction per page.

### SUMMARY OF THE INVENTION

The present invention may provide an image processing apparatus, an image forming apparatus, and an image processing method that substantially eliminate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an image processing apparatus, an image forming apparatus, and an image processing method particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus for an image forming apparatus including a line head array that forms an image by illuminating one or more illumination elements in correspondence with image data, the image processing apparatus including a detection part configured to detect a linear image extending in a sub-scanning direction in the image data; and an adjustment part configured to adjust a density of the linear image so that the energy used in illuminating the one or more illumination elements for forming the linear image is reduced compared to the energy used in forming the linear image without adjusting the density of the linear image.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating a direct transfer type tandem image forming apparatus according to an embodiment of the present invention;

FIG. 2 is a schematic diagram illustrating an intermediate type tandem image forming apparatus according to an embodiment of the present invention;

FIG. 3 is a block diagram illustrating a control configuration of an image forming apparatus according to an embodiment of the present invention;

FIG. 4 is a flowchart illustrating steps in performing density adjustment according to an embodiment of the present invention;

FIGS. 5A and 5B are schematic diagrams for describing a linear image that is subject to density adjustment according to an embodiment of the present invention;

FIG. 6 is a schematic diagram for describing a method for controlling detection of a line extending in a sub-scanning direction and adjustment of density of the detected line according to an embodiment of the present invention;

FIG. 7 is a schematic diagram for describing an example of reducing the workload of each dot (illumination element) of an LEDA head by adjusting the density of pixels constituting a line extending in a sub-scanning direction according to an embodiment of the present invention;

FIG. 8 is a schematic diagram illustrating an example of a 4 (horizontal direction)×3 (vertical direction) filter used for density adjustment according to an embodiment of the present invention; and

FIG. 9 is a schematic diagram illustrating another example of a 4 (horizontal direction)×3 (vertical direction) filter used for density adjustment according to an embodiment of the present invention.

### DETAILED DESCRIPTION OF THE PREFERRED EMBODIMENTS

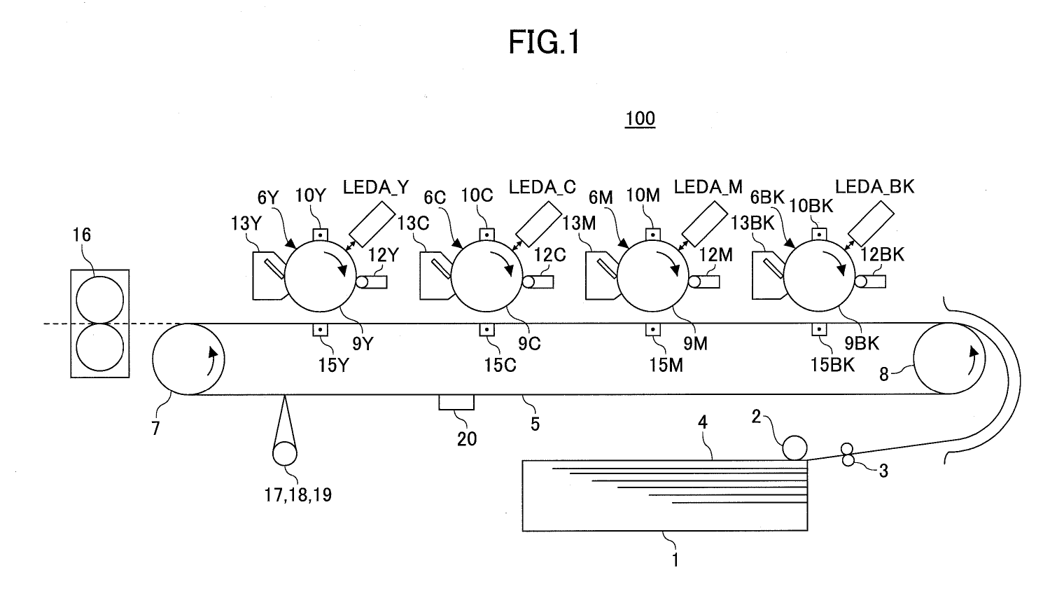

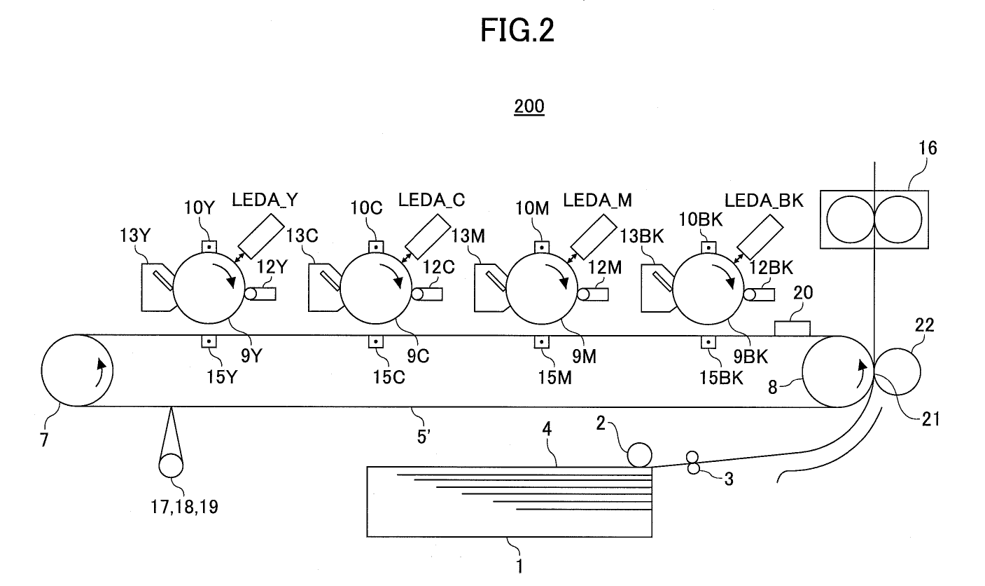

FIGS. 1 and 2 are schematic diagram illustrating an overall configuration of an image forming portion of an electrophotographic type image forming apparatus including an LEDA according to an embodiment of the present invention. More specifically, FIG. 1 illustrates a direct transfer type tandem image forming apparatus 100 (hereinafter also simply referred to as “image forming apparatus 100”) according to an embodiment of the present invention and FIG. 2 illustrates an intermediate type tandem image forming apparatus 200 (hereinafter also simply referred to as “image forming apparatus 200”) according to an embodiment of the present invention. A full color image is formed with the image forming apparatus 100 by attracting a sheet of recording medium (hereinafter simply referred to “paper”) such as a sheet of transfer paper, a sheet of recording paper, a sheet of film-like paper onto a conveyor belt, carrying the sheet of paper, and superposing toner images of black (Bk), magenta (M), cyan (C), and yellow (Y) on the sheet of paper. On the other hand, a full color image is formed with the image forming apparatus 200 by superposing toner images of black (Bk), magenta (M), cyan (C), and yellow (Y) on an intermediate transfer belt and transferring the superposed images as a whole onto a sheet of paper.

With reference to FIG. 1, the image forming apparatus 100 includes image forming parts (electrophotographic processing parts) 6Bk, 6M, 6C, 6Y corresponding to Bk, M, C, Y that are arranged along a conveyor belt (endless moving part) 5. In the embodiment illustrated in FIG. 1, a sheet of paper 4 is separated from plural sheets of paper loaded on a paper tray 1 and fed to the conveyor belt by a sheet-feed roller 2 and a separation roller 3. The image forming parts 6Bk, 6M, 6C, 6Y are arranged in this order from an upstream side with respect to a conveying direction of the conveyor belt 5. Other than forming images of different color, the image forming parts 6Bk, 6M, 6C, and 6Y have substantially the same internal structure. The image forming parts 6Bk, 6M, 6C, 6Y are configured to form a black image, a magenta image, a cyan image, and a yellow image, respectively. Accordingly, although only an image forming process performed with the image forming part 6Bk is explained in the description below, the description can be applied to an image forming process performed with the image forming parts, 6M, 6C, and 6Y. Thus, although the image forming parts 6M, 6C, and 6Y are illustrated in FIG. 1, a detailed description of the image forming processes performed by the image forming parts 6M, 6C, and 6Y is omitted.

In this embodiment, the conveyor belt 5 is an endless belt wound around a rotating drive roller 7 and a driven roller 8. The drive roller 7 is rotated by a drive motor (not illustrated). The drive motor, the drive roller 7, and the driven roller 8 serve as a driving part for moving (rotating) the conveyor belt 5. The paper 4 is fed starting from the topmost paper on stacked on the paper tray 1. Then, the paper 4, which is attracted to the conveyor belt 5 by electrostatic force, is first conveyed to the image forming part 6Bk. When the paper 4 reaches the image forming part 6Bk, a black toner image is transferred to the paper 4. The image forming part 6Bk includes a photoconductor drum 9Bk. The image forming part 6Bk also includes, for example, a charger 10Bk, an LEDA head LEDA_Bk, a developer 12Bk, a photoconductor cleaner 13Bk, and a electrostatic remover (not illustrated) that are provided at a periphery of the photoconductor drum 9Bk. The LEDA_Bk, M, C, Y perform exposure on the photoconductor drums 9Bk, 9M, 9C, and 9Y by emitting light to the photoconductor drums 9Bk, 9M, 9C, and 9Y at the image forming parts 6Bk, 6M, 6C, and 6Y, respectively.

The LEDA_Bk, M, C, Y include plural illumination elements which are fine-sized light emitting diodes (LEDs) arranged in a main scanning direction. Each illumination element corresponds to a single dot.

After the outer peripheral surface of the photoconductor drum 9Bk is uniformly charged by the charger 10Bk in the dark, the outer peripheral surface of the photoconductor drum 9BK is exposed by an irradiation light emitted from the LEDA_Bk array in correspondence with the black image. Thereby, an electrostatic latent image is formed. Then, the developer 12Bk makes the electrostatic latent image visible by applying toner to the electrostatic latent image. Thereby, a black toner image is formed on the photoconductor drum 9Bk.

Then, the black toner image is transferred to the surface of the paper 4 by a transfer device 15Bk provided at a position where the photoconductor drum 9Bk and the paper 4 on the conveyor belt 5 make contact (transfer position). Thus, by performing the transfer, the black toner image is formed on the After the black toner image is transferred to the surface of the paper 4, undesired residual toner remaining on the outer peripheral surface of the photoconductor drum 9Bk is removed by the photoconductor cleaner 13Bk. Then, the electrostatic remover (not illustrated) removes the static of the photoconductor drum 9Bk. Then, the photoconductor drum 9Bk stands by for the next image forming process.

Accordingly, the paper 4 having the black toner image transferred thereon is conveyed to the next image forming part 6M by the conveyor belt 5. By performing an image forming process at the image forming part 6M in substantially the same manner as the image forming process performed at the image forming part 6Bk, a magenta toner image is formed on the photoconductor drum 9M and transferred to the paper 4 in a manner superposed on the black toner image. Then, the paper 4 having the black and magenta toner images transferred thereon is conveyed to the next image forming part 6C by the conveyor belt 5. By performing an image forming process at the image forming part 6C in substantially the same manner as the image forming process performed at the image forming parts 6Bk and 6M, a cyan toner image is formed on the photoconductor drum 9C and transferred to the paper 4 in a manner superposed on the black and magenta toner images. Then, the paper 4 having the black, magenta, and cyan toner images transferred thereon is conveyed to the next image forming part 6Y by the conveyor belt 5. By performing an image forming process at the image forming part 6Y in substantially the same manner as the image forming processes performed at the image forming parts 6Bk, 6M, and 6C, a yellow toner image is formed on the photoconductor drum 9Y and transferred to the paper 4 in a manner superposed on the black, magenta, and cyan toner images. Thereby, a full color superposed image is formed on the paper 4. Then, the paper 4 having the superposed full color image formed thereon is removed from the conveyor belt 5 and fixed to the paper 4 by a fixing device 16. After the full color image is fixed to the paper 4, the paper is discharged outside of the image forming apparatus 100.

In FIG. 1, reference numerals 17, 18, and 19 indicate a light reflection type toner mark sensor that is used for correcting position deviation. Reference numeral 20 indicates a cleaning apparatus of the conveyor belt 5.

Instead of having the conveyor belt 5 illustrated in FIG. 1, the intermediate type tandem image forming apparatus 200 illustrated in FIG. 2 has an intermediate transfer belt (endless moving part) 5′ and a secondary transfer belt 22. The intermediate transfer belt 5′ is an endless belt wound around the rotating drive roller 7 and the driven roller 8. The toner images corresponding to black, magenta, cyan, and yellow are transferred to the intermediate transfer belt 5′ by the transfer devices 15Bk, 15M, 15C, and 15Y at the positions where the photoconductor drums 9Bk, 9M, 9C, 9Y and the intermediate transfer belt 5′ make contact (first transfer position). A full color image having superposed Bk, M, C, Y images are formed on the intermediate transfer belt 5′ by transferring the toner images on the intermediate transfer belt 5′. In forming an image, first, a sheet of paper 4 is fed starting from the topmost paper stacked on the paper tray 1. Then, the paper 4 is conveyed onto the intermediate transfer belt 5′. When the paper 4 reaches a position where the intermediate transfer belt 5′ and the paper 4 make contact (second transfer position 22), the full color toner image is transferred to the paper 4. A secondary transfer roller 22, which is positioned at the second transfer position 21, presses against the paper 4 on the intermediate transfer 5′ for increasing transfer efficiency. The secondary transfer roller 22 is closely adhered to the intermediate transfer belt 5′ and has no attaching/detaching mechanism.

The image forming apparatus 100 and the image forming apparatus 200 have substantially the same configuration and components except that the image forming apparatus 100 forms a toner image on a sheet of paper 4 by a single first transfer process whereas the image forming apparatus 200 forms a toner image on the intermediate transfer belt 5′ by transferring the image on the intermediate transfer belt 5′ and then transferring the image onto the paper 4. It is to be noted that reference numeral 20 indicates a cleaning device for cleaning residual toner remaining on the surface of the intermediate transfer belt 5′.

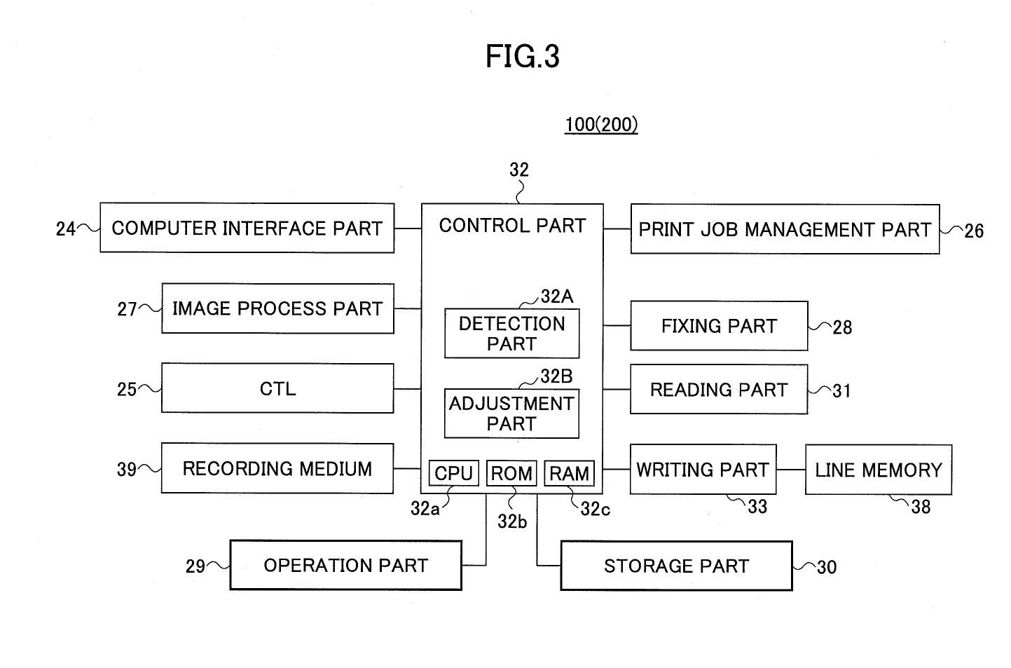

FIG. 3 is a block diagram illustrating a control configuration of an image forming apparatus 100 (200) according to an embodiment of the present invention. That is, the control configuration including the below-described control part (image processing apparatus) 32 illustrated in FIG. 3 can be used in both the image forming apparatus 100 of FIG. 1 and the image forming apparatus 200 of FIG. 2.

In FIG. 3, a control part 32 (also referred to as “image processing apparatus”) is provided as the center of the control configuration of the image forming apparatus 100 (200) according to an embodiment of the present invention. A computer interface part 24, a controller (CTL) part 25, a print job management part 26, an image process part 27, a fixing part 28, an operation part 29, a storage part 30, a reading part 31, and a writing part 33 are connected to the control part 32, so that the computer interface part 24, the controller (CTL) part 25, the print job management part 26, the image process part 27, the fixing part 28, the operation part 29, the storage part 30, the reading part 31, and the writing part 33 can communicate with each other. Further, a line memory 38 (for skew correction) is connected to the writing part 33.

The computer interface part 24 is for communicating with a terminal that requests the image forming apparatus 100, 200 to perform a printing process. The controller (CTL) part 25 is for transmitting a printing request from terminal and/or image data to the control part 32. The print job management part 26 is for managing the order of performing print jobs requested to the image forming apparatus 100, 200. The image process part 27 is for obtaining image data stored in an image memory part (not illustrated) and generating a toner image by using an electrophotographic method based on the obtained image data, and transferring the toner image to a sheet of paper 4. In a case where the image process part 27 detects position deviation, the image process part 27 corrects the position deviation.

The fixing part 28 is for fixing the toner image onto the paper 4 by applying heat and pressure to the paper 4 having the toner image transferred thereto by the image process part 27. The operation part 29 is for displaying the status of the image forming apparatus 100, 200 and receiving input (requests) to the image forming apparatus 100, 200. The storage part 30 is for retaining status data of the image forming apparatus at a certain period. The reading part 31 is for optically reading data printed on a paper or the like and converting the read data into electric signals. The writing part 33 is for converting image data transmitted from the controller part 25 into signals causing an LED of the writing part to illuminate and illuminating the LED. The line memory 32 is for temporarily storing data transmitted from the controller part 25 in a buffer, so that the stored data can be used in adjusting the amount of skew (skew amount) in an image processing process. The control part 32 is for controlling the series of processes/operation performed by the computer interface part 24, the controller (CTL) part 25, the print job management part 26, the image process part 27, the fixing part 28, the operation part 29, the storage part 30, the reading part 31, and the writing part 33 connected to the control part 32. Thus, as described in detail below, the control part 32 functions as a detection part 32A that detects a linear image extending in the sub-scanning direction in image data. Further, as described in detail below, the control part 32 includes an adjustment part 32B that adjusts a density of an image the energy used in illuminating one or more illumination elements of an LED_A Bk, Y, M, and C for forming the linear image is reduced compared to the energy used in forming the linear image without adjusting the density of the linear image. In FIG. , the control part 32 also includes a CPU (Central Processing Unit) 32a, a ROM (Read Only Memory) 32b, and a RAM (Random Access Memory) 32b. The control part 32 reads out a program code stored in the ROM or a program recorded in a computer-readable recording medium 39, loads the read out program code to the RAM 32b, and uses the RAM 32b as a work area and a data buffer for performing various controls (e.g., line detection, density adjustment) based on the program code(s).

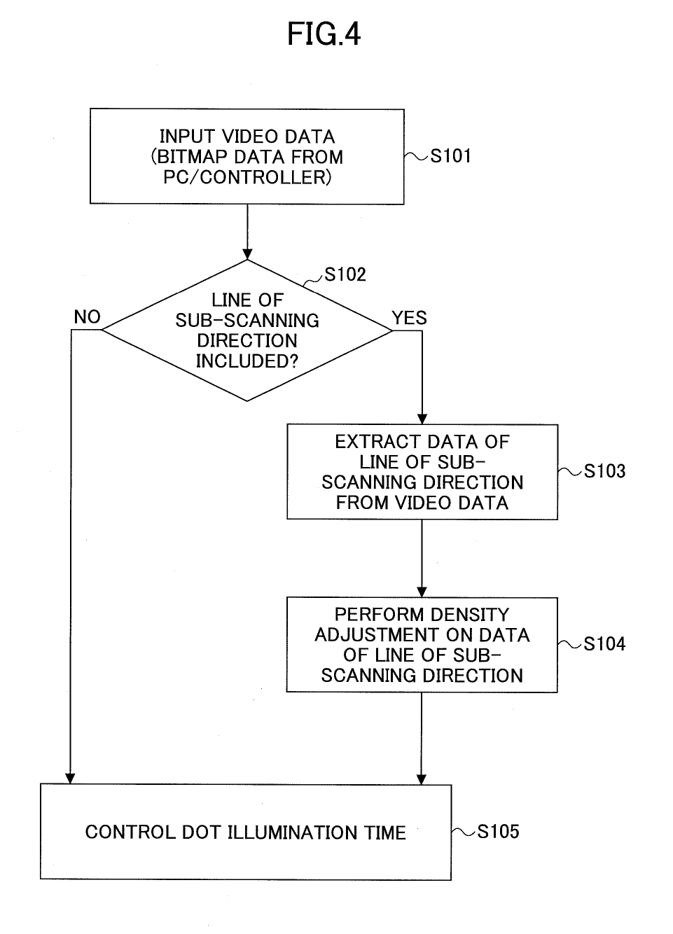

FIG. 4 is a flowchart illustrating steps in performing density adjustment according to an embodiment of the present invention. In FIG. 4, image data (video data (bitmap data)) is input from a personal computer (PC) or the controller part 25 (Step S101). Then, it is determined whether one or more lines being oriented in a sub-scanning direction and being equal to or more than a predetermined length are included in the input video data (Step S102).

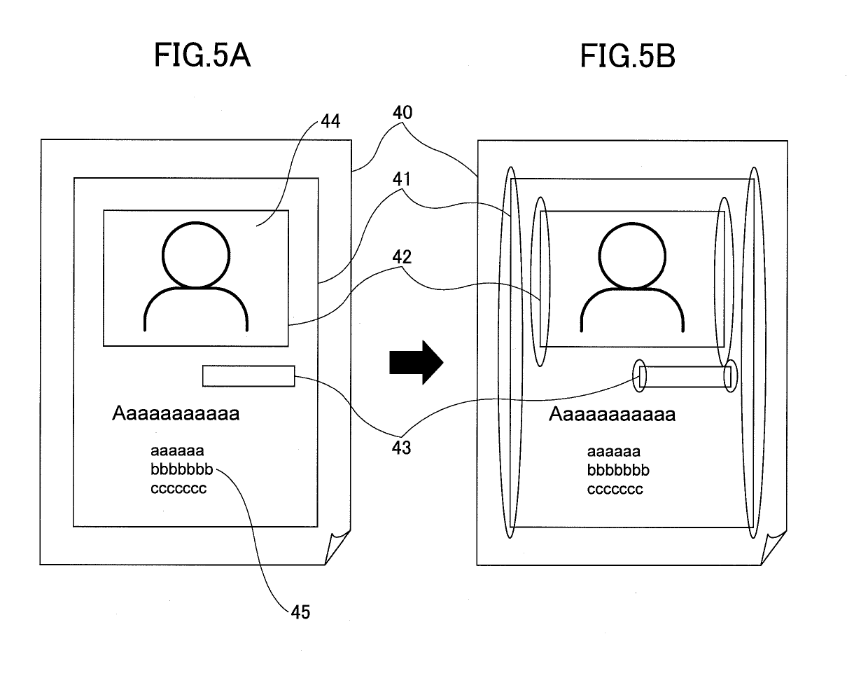

The “predetermined length” is described with reference to FIGS. 5A and 5B. FIGS. 5A and 5B illustrates a page 40 having a portrait 44 and letters (characters) 45 printed inside a frame. The page 40 includes three frames (large size, medium size, small size) delineated with lines 41, 42, and 43, respectively. In this embodiment, the vertical long length line 41 extending in the sub-scanning direction and the vertical medium length line extending in the sub-scanning direction correspond to a line having a predetermined length, respectively. In this embodiment, although a row of characters can be written in the main scanning direction by using the vertical short length line 43, the vertical short length line 43 is less than the predetermined length. The predetermined length is discretionally set as a threshold of Step S102 in view of, for example, the size of a letter (character).

Accordingly, in a case where the video data includes a vertical line that is shorter than the predetermined length such as the line 43 (No in Step S102), the video data is sent to the LEDA without performing a density adjustment process on the video data, and the time for illuminating each dot (illumination element) of the LEDA is controlled based on the input image data (Step S105).

On the other hand, in a case where the video data is determined to include a line of a sub-scanning direction that is equal to or greater than the predetermined length (Yes in Step S102), data of the line of the sub-scanning direction is extracted from the video data (Step S103). Then, a density adjustment process is performed on the extracted data of the line of the sub-scanning direction (Step S104). Then, the video data including the density adjusted data is output to the LEDA. Accordingly, each dot (illumination element) of the LEDA is controlled based on the video data including the density adjusted data (Step S105).

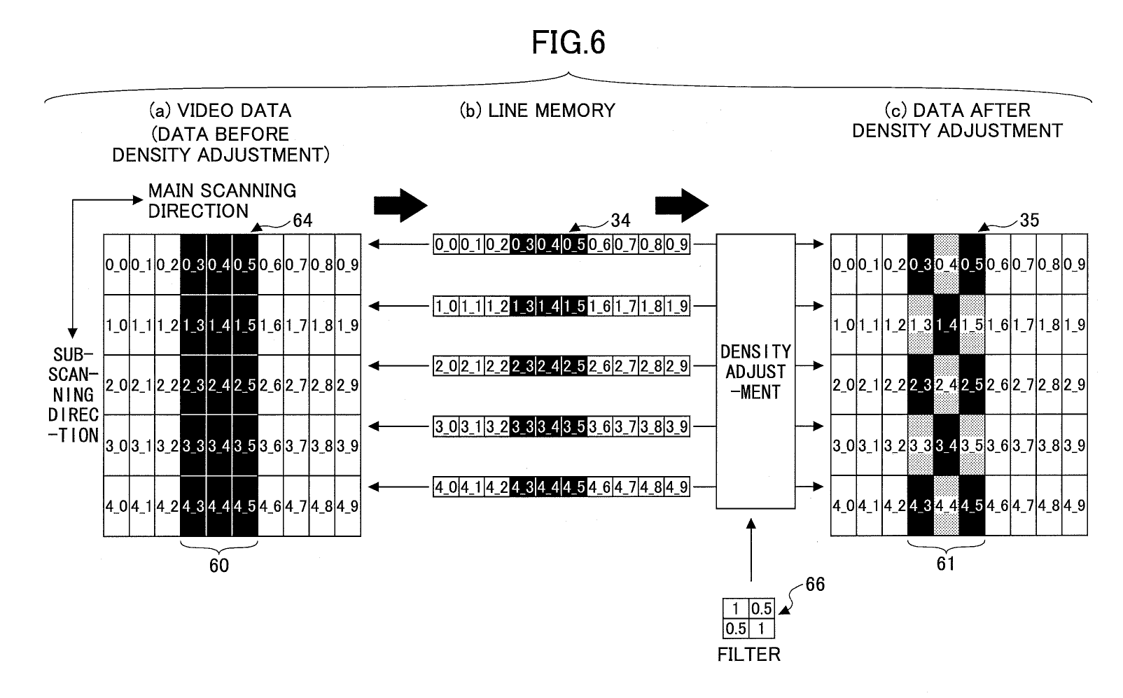

FIG. 6 is a schematic diagram for describing a method for detecting (extracting) data of a vertical line (line of sub-scanning direction) and performing density adjustment on the extracted data according to an embodiment of the present invention. In FIG. 6, (a) illustrates an exemplary configuration of video data including data of a line of the sub-scanning direction. In this embodiment, the video data includes a line 60 having a width equivalent to 3 dots (i.e. the line illustrated with black pixels in (a) of FIG. 6). In FIG. 6, (c) illustrates the video data after the density adjustment is performed.

In this embodiment, reference numeral 61 indicates the line of the sub-scanning direction. The ratio between the pixels of the line 61 having the same density as the pixels of the line 60 and the pixels of the line 61 having half (½) the density as the pixels of the line 60 is 1:1. In other words, in a case of printing an image having a line of a sub-scanning direction (in this embodiment, the line 60 in (a) of FIG. 6), the pixels of the line of the sub-scanning direction are subject to density adjustment, so that image data including data of a line having pixels of different gradation is output (in this embodiment, the line 61 in (c) of FIG. 6).

In performing density adjustment on pixels as described above, first, image data (video data (bitmap data)) 64 is input from a personal computer (PC) or the controller part 25. The image data are stored line by line into the line memory 38. In this embodiment, it is assumed that the line memory 38 is formed of 10 lines. As described above, it is determined whether the data stored in the line memory 38 includes a line of the sub-scanning direction that is equal to or greater than the predetermined length (Step S102). In a case where the line of the sub-scanning direction that is equal to or greater than the predetermined length is included (yes in Step S102), only the pixels corresponding to the line are subject to density adjustment (Step S104). Thereby, image data including density adjusted line data is generated. In FIG. 6, reference numeral 66 indicates a filter used in performing the density adjustment. The size of the filter 66 is discretionary. Each cell of the filter 66 may be set with a ratio ranging from 0 to 1 for indicating the density after adjustment with respect to the initial density (i.e. density before adjustment). In this embodiment, the filter 66 is a 2×2 matrix filter having a ratio (coefficient) of (1, 0.5, 0.5, 1) starting from the upper left cell of the matrix filter.

The density adjustment using the filter 66 is performed by aligning and superposing (overlapping) plural filters 66 on the entire line 60 and multiplying the coefficients of the filter 66 to overlapped corresponding pixels that form the line 60 having the initial density. Thereby, density adjusted image data is obtained. More specifically, data of the line 34 is multiplied with the ratios (1, 0.5, 0.5, 1) indicated in the cells of the filter 66. Based on the multiplication result, density adjusted image data 35 illustrated in (c) of FIG. 6 can be obtained. It is to be noted that the adjustment of density is substantially equivalent to controlling the energy of the light source of the LEDA.

In the embodiment of FIG. 6, the size of the filter 66 is a 2×2 matrix filter whereas the line 60 of the sub-scanning direction has a width equivalent to 3 dots of the LEDA. Thus, the size of the filter 66 and the line 60 of the sub-scanning direction do not completely match. However, this mismatch can be overcome by repetitively applying the filter 66 to the line 60. Further, in the embodiment of FIG. 6, the width of the filter 66 is an even number (two pixels) whereas the width of the line 60 (equivalent to 3 horizontal dots) is an odd number (3 pixels). Therefore, even if the filter 66 is repetitively applied to the line 60, there will be a “remainder” part (in this embodiment, the line beginning from 0_6 in FIG. 6). In a case of binary image data, the calculation results for the “remainder” part would be 0 because the value of the initial image data is 0. However, in a case of multiple value image data (as in this embodiment), a value other than 0 may be obtained from the calculation results for the “remainder” part. Therefore, in the case of multiple value image data (as in this embodiment), the calculation results for the “remainder” part is to be ignored. Accordingly, calculation results for the line 60 (equivalent to 3 horizontal dots) can be obtained by ignoring the calculation results for the “remainder” part.

Then, in performing a printing process with the image forming apparatus 100, 200, each dot (illumination element) of the LEDA head LEDA_Bk, LEDA_M, LEDA_C, and LEDA_Y is illuminated in accordance with the density adjusted data 35, and the image process part 27 forms an image on a sheet of paper 4 in correspondence with the illuminated dots (illumination elements) of the LEDA head LEDA_Bk, LEDA_M, LEDA_C, and LEDA_Y. In this printing process, the control part 32 controls illumination energy and performs density adjustment by controlling the time (period) in which the dots are illuminated (illumination time) and controlling the amount of current that flow in the dots (illumination elements).

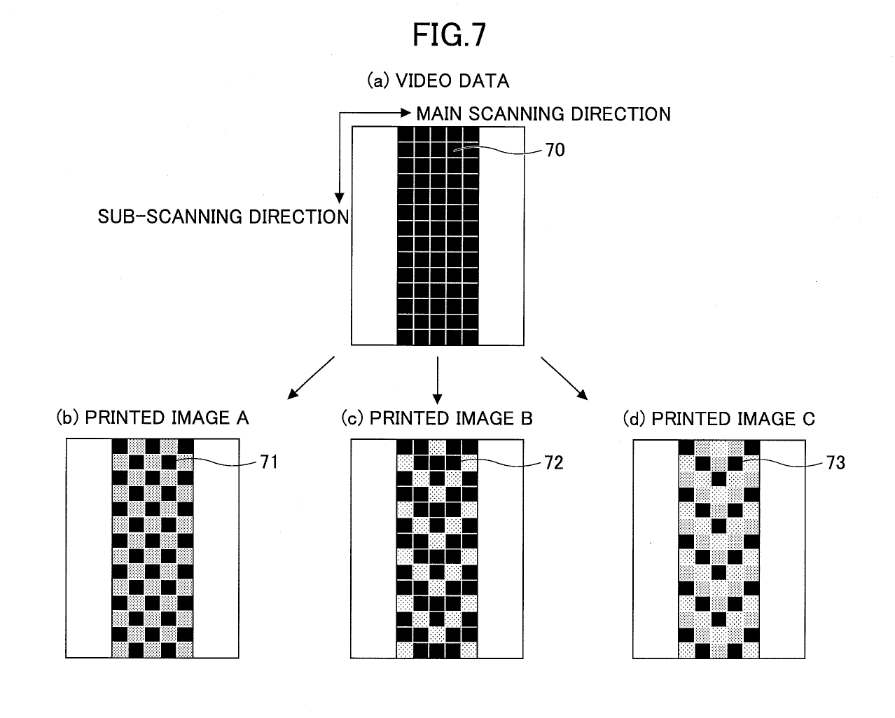

FIG. 7 is a schematic diagram for describing an example of reducing the workload (e.g., illumination energy) of each dot (illumination element) of an LEDA head by adjusting the density of pixels constituting a line extending in a sub-scanning direction according to an embodiment of the present invention. More specifically, (a) of FIG. 7 illustrates an exemplary configuration of video data including data of a line 70 extending in the sub-scanning direction and having a width (length with respect to the main scanning direction) equivalent to 5 dots. Further, (b) of FIG. 7 illustrates a printed image A including a line 71 in which the ratio between the pixels having the same density as those of the line 70 and the pixels having ½ the density as those of the line 70 is 1:1. In the example of (b), density adjustment is performed by multiplying the data of the line 70 with the 2×2 filter 66 of FIG. 6. With the density adjustment in the example of (b), the workload for each dot becomes ¾ compared to a case of not performing any density adjustment. Thereby, density adjusted image data 35 is obtained in a similar manner as FIG. 6.

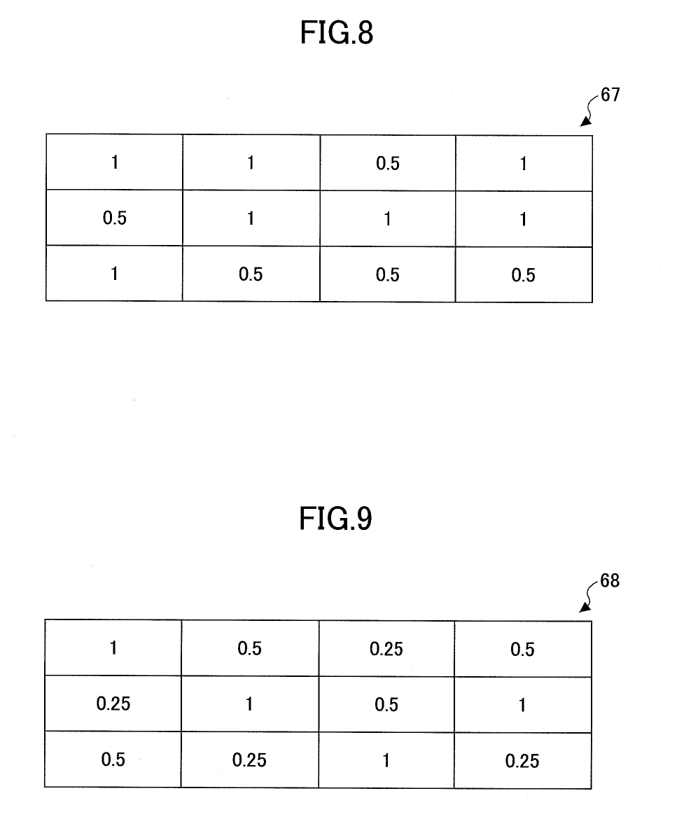

Further, (c) of FIG. 7 illustrates a printed image B including a line 72 in which the ratio between the pixels having the same density as those of the line 70 and the pixels having ¼ the density as those of the line 70 is 2:1. In the example of (c), density adjustment is performed by multiplying the data of the line 70 with the 4 (horizontal direction)×3 (vertical direction) filter 67 illustrated in FIG. 8. With the density adjustment in the example of (c), the workload for each dot becomes ¾ compared to a case of not performing any density adjustment. In the example of (c), the filter 67 has a ratio (coefficient) of (1, 1, 0.5, 1, 0.5, 1, 1, 1, 1, 0.5, 0.5, 0.5) starting from the upper left cell of the matrix filter. Similar to the example described above with reference to FIG. 6, the density adjustment using the filter 67 is performed by aligning and superposing (overlapping) plural filters 67 on the entire line 70 and multiplying the coefficients of the filter 67 to overlapped corresponding pixels that form the line 70 having the initial density. Thereby, density adjusted image data 35 is obtained in a similar manner as FIG. 6.

Further, (d) of FIG. 7 illustrates a printed image B including a line 72 in which the ratio between the pixels having the same density as those of the line 70, the pixels having ½ the density as those of the line 70, and the pixels having ¼ the density as those of the line 70 is 1:1:1. In the example of (d), density adjustment is performed by multiplying the data of the line 70 with the 4 (horizontal direction)×3 (vertical direction) filter 68 illustrated in FIG. 9. With the density adjustment in the example of (d), the workload for each dot becomes 7/12 compared to a case of not performing any density adjustment. In the example of (d), the filter 68 has a ratio (coefficient) of (1, 0.5, 0.25, 0.5, 0.25, 1, 0.5, 1, 0.5, 0.25, 1, 0.25) starting from the upper left cell of the matrix filter. Similar to the example described above with reference to FIG. 6 and (c) of FIG. 7, the density adjustment using the filter 68 is performed by aligning and superposing (overlapping) plural filters 68 on the entire line 70 and multiplying the coefficients of the filter 68 to overlapped corresponding pixels that form the line 70 having the initial density. Thereby, density adjusted image data 35 is obtained in a similar manner as FIG. 6.

As illustrated in FIG. 7, the density of pixels of the line 70 can be changed by changing the size of the filter and/or the ratio (coefficient) of the cells of the matrix filter 66, 67, 68.

Accordingly, density adjusted image data 35 including the line extending in the sub-scanning direction 71, 72, 73 can be obtained. As a result, the time (period) in which the dots are illuminated (illumination time) can be adjusted in accordance with the density of the pixels of the image data. After the density of the pixels of the line of the sub-scanning direction is adjusted, the density of the pixels of the line of the sub-scanning direction can be further adjusted by aligning plural small size filters. Thereby, the ratio of the density of the entire line of the sub-scanning direction can be set more specifically. Further, the workload for each dot can be further reduced by having the adjustment part 32B change the width of the line of the sub-scanning direction.

Particularly, in a case where the line of the sub-scanning direction has a width equivalent to 1 dot, the line of the sub-scanning direction may be shifted a single dot in the main scanning direction along with performing the above-described density adjustment. This enables the workload (e.g., illumination energy) for a particular dot to be reduced. Although printing position (image forming position) shifts whenever a page is printed in the case where the line of the sub-scanning direction is shifted in the main scanning direction, the shift of the printing position can be ignored because the shift of the printing position is no greater than 1 dot. This, however, cannot be performed in a case where there is an adjacent pixel in the direction in which the line of the sub-scanning direction is to be shifted. It is to be noted that, in the case where the line of the sub-scanning direction is shifted a single dot, a read-out address of the memory is shifted to a degree equivalent to a shift of a single dot and data corresponding to the shifted address is read out. Based on the read out data, a pixel, which is positioned one dot next to the pixel initially to be illuminated, is illuminated.

In this embodiment where the line of the sub-scanning direction having a width equivalent to 1 dot is shifted one dot in the main scanning direction an illumination element, which is positioned one dot adjacent to the illumination element initially to be illuminated, is illuminated. Unlike the method of the related art example, the shift of the line of the sub-scanning direction does not cause the image of the entire image to shift because only the line of the sub-scanning direction having a width equivalent to 1 dot is shifted according to the above-described embodiment of the present invention.

It is to be noted that the filter 66, 67, 68 used in the above-described embodiment is preferred to have a size that matches, for example, a dither cycle. Interference with respect to dither can be prevented by using a filter 66, 67, 68 having a filter size that matches a dither cycle. Therefore, it is preferable for the adjustment part 32A to use different types of filters according to the type of dither.

With the above-described embodiments of the present invention, even in a case of printing a continuous image where the image includes a line extending in a sub-scanning direction, the workload of an illumination element of an LEDA head can be reduced without causing deviation of printing position. This is because the above-described embodiment of the image forming apparatus 100, 200 is controlled in a manner that the density of the pixels constituting the line is adjusted and the time for illuminating a single illumination element (dot) of the LEDA head is shortened.

Further, with the above-described embodiments of the present invention, the LEDA can be prevented from wear owing to the reduction of the workload of the illumination elements of the LEDA.

Further, with the above-described embodiments of the present invention, density can be adjusted by simple calculation owing to the use of a filter(s) for density adjustment.

Further, with the above-described embodiments of the present invention, the density of each dot can be adjusted without interference with respect to dither owing to the matching of the filter size with the dither cycle or the use of different filters in correspondence with the type of dither.

In a case of printing an image including a line extending in the sub-scanning direction and having a width equivalent to 1 dot according to the above-described embodiments of the present invention, a target illumination element, which is to be initially illuminated, is avoided from being illuminated. More specifically, in the case of printing an image including a line extending in the sub-scanning direction and having a width equivalent to 1 dot, an illumination element positioned adjacent to the target illumination element is illuminated instead of illuminating the target illumination element. Thereby, the target illumination element is prevented from being illuminated for a long time. Thus, illumination time can be significantly reduced. As a result, illumination energy of a particular dot (illumination element) can be reduced.

With the above-described embodiments of the present invention, in the case where the line of an image having a width equivalent to 1 dot is shifted 1 dot in the main scanning direction, only the line is shifted rather than shifting the entire image of a single page. Therefore, the control of reading out data from the memory is simple. Thus, the 1 dot shift has minimal effect in controlling the image forming apparatus.

With the above-described embodiments of the present invention, the energy for illuminating the illumination element can be reduced by reducing the time of illuminating the illumination element and reducing the electric current flowing in the illumination element.

With the above-described embodiments of the present invention, there is no need to provide a memory for detecting a line extending in a sub-scanning direction because a line memory, which is used for correcting skew, can be used for detecting the line extending in the sub-scanning direction.

The present invention is not limited to the specifically disclosed embodiments, and variations and modifications may be made without departing from the scope of the present invention.

The present application is based on Japanese Priority Application No. 2010-197575 filed on Sep. 3, 2010, the entire contents of which are hereby incorporated herein by reference.

What is claimed is:

1. An image processing apparatus for an image forming apparatus including a line head array that forms an image by illuminating one or more illumination elements in correspondence with image data, the image processing apparatus comprising
a detection part configured to detect a linear image extending in a sub-scanning direction in the image data; and
an adjustment part configured to adjust a density of the linear image so that the energy used in illuminating the one or more illumination elements for forming the linear image is reduced compared to the energy used in forming the linear image without adjusting the density of the linear image.

2. The image processing apparatus as claimed in claim 1, wherein the adjustment part is configured to use a filter for adjusting the density of the linear image, wherein the filter is set with a ratio indicating the density of the image before being adjusted and the density of the image after being adjusted.

3. The image processing apparatus as claimed in claim 2, wherein the filter has a size that matches a dither cycle.

4. The image processing apparatus as claimed in claim 2, wherein the adjustment part is configured to change the filter in correspondence with a type of dither.

5. The image processing apparatus as claimed in claim 1, wherein the adjustment part is configured to shift the linear image to a main scanning direction in a case where the linear image has a width equivalent to a single dot.

6. The image processing apparatus as claimed in claim 5, wherein the adjustment part is configured to shift the linear image one dot to the main scanning direction.

7. The image processing apparatus as claimed in claim 1, wherein the adjustment part is configured to change a width of the linear image.

8. The image processing apparatus as claimed in claimed 1, wherein the adjustment part is configured to reduce a time of illuminating the one or more illumination elements.

9. The image processing apparatus as claimed in claim 1, wherein the adjustment part is configured to reduce an electric current flowing in the one or more illumination elements.

10. The image processing apparatus as claimed in claim 1, wherein the detection part is configured to detect the linear image by using a line memory used for skew correction.

11. An image forming apparatus comprising:
the image processing apparatus as claimed in claim 1.

12. An image processing method for an image forming apparatus including a line head array that forms an image by illuminating one or more illumination elements in correspondence with image data, the image processing method comprising the steps of:
detecting a linear image extending in a sub-scanning direction in the image data; and
adjusting a density of the linear image so that the energy used in illuminating the one or more illumination elements for forming the linear image is reduced compared to the energy used in forming the linear image without adjusting the density of the linear image.

13. A computer-readable recording medium on which a program is recorded for causing a computer to perform an image processing method for an image forming apparatus including a line head array that forms an image by illuminating one or more illumination elements in correspondence with image data, the image processing method comprising the steps of:
detecting a linear image extending in a sub-scanning direction in the image data; and
adjusting a density of the linear image so that the energy used in illuminating the one or more illumination elements for forming the linear image is reduced compared to the energy used in forming the linear image without adjusting the density of the linear image.
